(19) United States
(12) Patent Application Publication
(10) Pub. No.: US 2011/0150205 A1
(43) Pub. Date: Jun. 23, 2011

(54) SYSTEM AND METHOD FOR PREFFERED PROVIDER SERVICES IN AN ENHANCED DIRECTORY ASSISTANCE SYSTEM

(76) Inventors: Christine Baumeister, Schwenksville, PA (US); Robert Pines, New York, NY (US)

(21) Appl. No.: 12/953,858

(22) Filed: Nov. 24, 2010

Related U.S. Application Data
(63) Continuation of application No. 11/203,438, filed on Aug. 11, 2005, now abandoned.
(60) Provisional application No. 60/601,158, filed on Aug. 12, 2004.

(51) Int. Cl. H04M 3/42

(52) U.S. Cl. 379/218.01

(57) ABSTRACT

An enhanced directory assistance system includes a directory assistance platform configured to receive calls from at least one requester seeking a listing and a listing database, coupled to the directory assistance platform configured to store a plurality of listings. At least one listing has a preferred status. When the requester contacts the directory assistance platform seeking the listing, a customer service representative at the directory assistance platform retrieves listings that meet the requester's search requirement, at least one of which is a listing having a preferred status. The at least one listing having a preferred status is given a more prominent display to the customer service representative than the remaining listings among the plurality of listings that do not have a preferred status.

### RELATED APPLICATIONS

This application is a continuation of U.S. patent application Ser. No. 11/203,438 filed on Aug. 11, 2005, which in turn claims the benefit of priority from U.S. Provisional Patent Application No. 60/601,158, filed on Aug. 12, 2004, the entirety of which are incorporated herein by reference.

### FIELD OF THE INVENTION

The present invention relates to the field of enhanced directory assistance services. More particularly, the present invention relates to a system and method for giving priority to retrieved listings in response to directory assistance requests.

### BACKGROUND OF THE INVENTION

In typical directory assistance systems callers use the system requests directory assistances to look for one of two things: information related to a specific entry, such as a home or business telephone, or, alternatively, they request information related to a general inquiry such as a business type or category.

In the later situation, the caller may ask for listings for auto-shops, restaurants, movie theaters, retail stores, museums, tourist cites etc. . . . In order to perform such searches, the customer service representative or an automated operator initiates a search using terms such as keywords or other such look-up terms with various categories in order to develop a list of possible results to give to the requester.

However, because these types of searches are generalized, numerous listing may be pulled up for each search term. For example, if a caller requests movie theaters in the area of Bethlehem Pa., a number of listings will be retrieved that meet the search criteria.

In such situations in the present directory assistance systems, the operator needs to input the search criterion each time the requester makes the request. In this configuration, an operator handling a particular call may simply be given a list of results using some form of proximity ordering, with the closest (geographically speaking) listing being posted to the top of the list for reading to the caller.

### OBJECTS AND SUMMARY OF THE INVENTION

As such, it is an object of the present invention to provide a directory assistance system and method, that permits a more prominent display of listings belonging to paid advertisers to the customer service representative, in response to inquiries from a caller.

In addition to prominently display to the customer service representative, it is another object of the present invention to provide additional preferences to paid advertisers in conjunction with the prominent display of their listing when such a listing meets the search criteria for various categories set by the caller.

To this end, the present invention provides for an enhanced directory assistance system that includes a directory assistance platform configured to receive calls from at least one requester seeking a listing and a listing database, coupled to the directory assistance platform configured to store a plurality of listings. At least one listing has a preferred status. When the requester contacts the directory assistance platform seeking the listing, a customer service representative at the directory assistance platform retrieves listings that meet the requester's search requirement, at least one of which is a listing having a preferred status. The at least one listing having a preferred status is given a more prominent display to the customer service representative than the remaining listings among the plurality of listings that do not have a preferred status.

### BRIEF DESCRIPTION OF THE DRAWINGS

The subject matter regarded as the invention is particularly pointed out and distinctly claimed in the concluding portion of the specification. The invention, however, both as to organization and method of operation, together with features, objects, and advantages thereof may best be understood by reference to the following detailed description when read with the accompanying drawings in which:

FIG. 1 is a diagram of a communication assistance system of the present invention in accordance with one embodiment of the present invention;

FIG. 2 is an internal diagram of a directory assistance platform from FIG. 1, in accordance with one embodiment of the present invention;

FIG. 3 is a prior art listing for a directory assistance system;

FIG. 4 is a prior art results table for a directory assistance system;

FIG. 5 is a listing for the communication assistance system, in accordance with one embodiment of the present invention;

FIG. 6 is flow chart depicting a call from a requester to the communication assistance system of FIG. 1, in accordance with one embodiment of the present invention;

FIG. 7 is screen shot of a search page for the communication assistance system of FIG. 1, in accordance with one embodiment of the present invention;

FIG. 8 is a flow chart depicting a call from a requester to the communication assistance system of FIG. 1, in accordance with one embodiment of the present invention;

FIG. 9 is a screen shot of a search results page in accordance with one embodiment of the present invention;

FIG. 10 is a screen shot of a search results page in accordance with another embodiment of the present invention; and

FIG. 11 is a screen shot of a search results page in accordance with another embodiment of the present invention.

### DETAILED DESCRIPTION

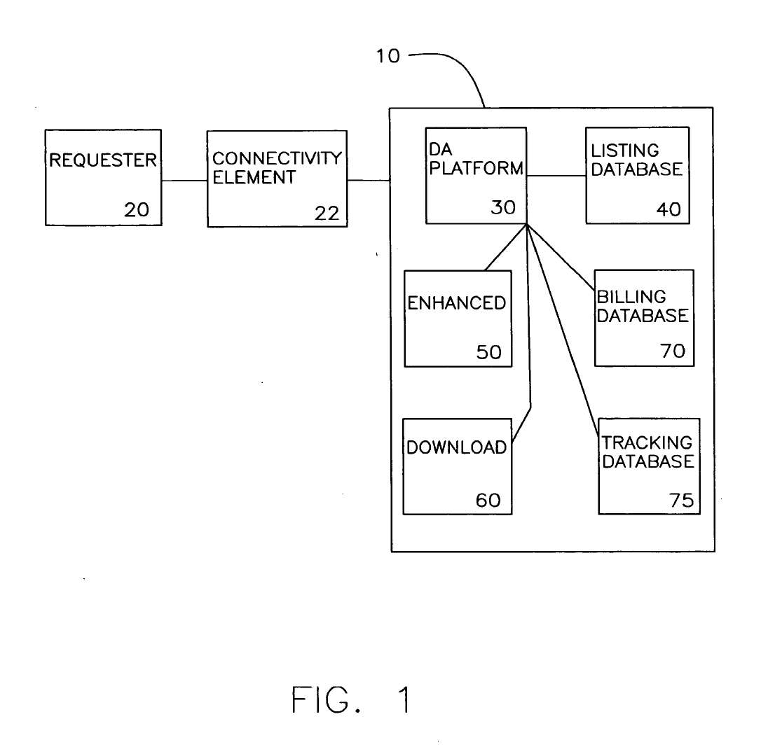

As illustrated in FIG. 1, an enhanced directory assistance system 10 is shown for use by a requester 20. As shown, requester 20 connects with enhanced directory assistance system 10 via connectivity element 22 to request a listing with a desired category of goods or services. Once the call enters system 10, the communication is handled by directory assistance platform 30 (hereinafter DA platform 30). DA platform 30 obtains the desired listings from a listing database 40 and sends the listing to DA platform 30 to complete the call with requester 20. DA platform 30 after obtaining the desired listing from listing database 40 sends the appropriate information to tracking database 75 and billing database 70. An enhanced service module 50 and download features module are coupled to DA platform 30 in order to provide additional services to requester 20. Additional details for these modules are set forth below.

In the present description, requester 20 is described as a user having a standard cell phone in order to demonstrate the salient features of the present invention. However, it is understood that requester 20 may include but is not limited to a user employing a VoIP phone, personal computer, PDA (Personal Digital Assistant), landline phone or any other personal communication device.

A connectivity element 22 is disposed between requester 20 and system 10 in order to facilitate communications between the two. In the case of the present invention, connectivity element 22 is described as being a cellular service provider for requester 20, for exemplary purposes. However, it is understood that connectivity element 22 may refer to any intermediate communication medium capable of handling communications between system 10 and requester 20, including the traditional Public Switched Telephone Network (PSTN). For example, in the case where requester 20 is operating a VoIP phone or other such internet based communication technology, connectivity element 22 may simply be the Internet or other privately managed servers.

Although FIG. 1 illustrates only a single enhanced directory assistance system 10, it is understood that a number of systems 10 may be interconnected with one another over widely spaced geographic locations for handling requests at all times of the day, for handling request overflow, and for backup redundancy.

As illustrated in FIG. 1, enhanced directory assistance system 10 maintains a directory assistance platform 30. DA platform 30 is configured to be the primary component for receiving and processing incoming requests from requester 20. It is understood that DA platform 30 may be comprised of a single component or more commonly comprised of a series of interlinked switches, ACD (Automatic Call Distribution) modules, operator terminals and other connectivity equipment. Furthermore, it is understood that DA platform 30 may employ live operators at operator terminals, completely automated response platforms, or a combination of the two for handling all of the features disclosed herein.

In addition to adding automated response options to DA platform 30, system 10 may also employ voice or speech recognition of requester 20. In this instance, DA platform 30 offers a series of automated options to select from, and requester 20 may respond verbally.

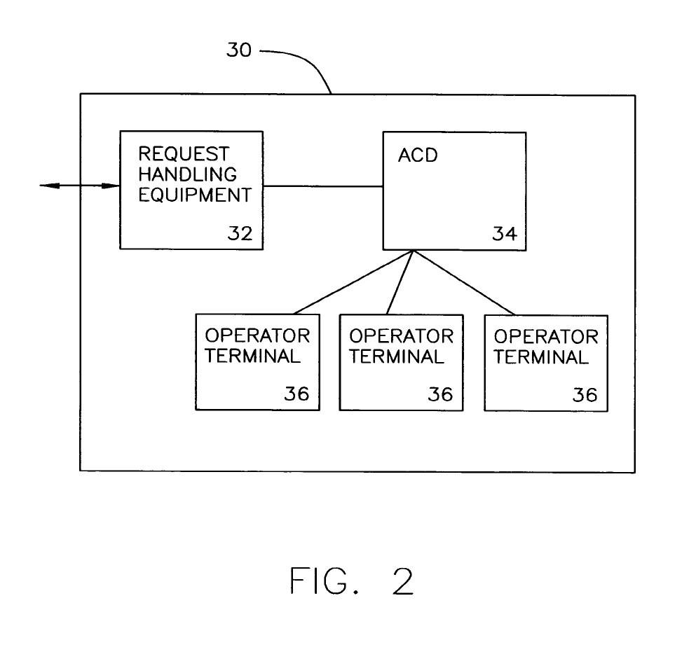

In an exemplary arrangement illustrated in FIG. 2, DA platform 30 typically comprises call or request handling equipment 32, ACD 34 and a plurality of operator terminals 36. Communications such as calls from requester 20 are transmitted to system 10 by connectivity equipment 22 an on to handling equipment 32. Handling equipment 32 sends the communication to ACD (Automatic Call Distribution) 34 to spread the calls to the various operator terminals 36 for addressing the specific requests of requester 20.

Returning to FIG. 1, DA platform 30 within system 10 is connected first to a listing database 40. Listing database 40 is configured to store the necessary data to handle standard requests from requester 20, such as requests for telephone numbers or other such connectivity information such as physical addresses, e-mail addresses, web-listings etc. . . . .

DA platform 30 is further connected to an enhanced services module 50. Enhanced services module 50 is configured to track certain advanced directory assistance services such as direction requests, reservation services, movie listings or other similar information services not directly related to connectivity.

In one embodiment of the present invention, as illustrated in FIG. 1, DA platform 30 of system 10 further maintains a connection to a download features module 60. Download features module 60 is configured to store data associated with requests for downloadable data items such as digital video clip, digital audio clips or executable files such as digital video games.

Listing database 40, enhanced services module 50 and download features module 60 are shown as single units within the confines of system 10. However it is understood that such databases and modules may both be employed as a physical array of devices and further may be handled off site or even by third party vendors.

Also, illustrated in FIG. 1 system 10 maintains a billing database 70 for maintaining and storing billing records related to the search for any other related services provided to requester 20. Billing database 70 further maintains records related to the providing of preferred provider features discussed below in order to properly bill the advertising parties. Further to this arrangement, tracking database 75 is also coupled to both DA platform 30 and billing database 70 to assist billing database 70 in generating and storing proper billing records for preferred provider services rendered as discussed below. It is understood that although billing and tracking databases 70 and 75 are pictured separately, any similar arrangement where such data is stored in a single storage unit or even in 3^{rd} party off-site storage units is also within the contemplation of the present invention.

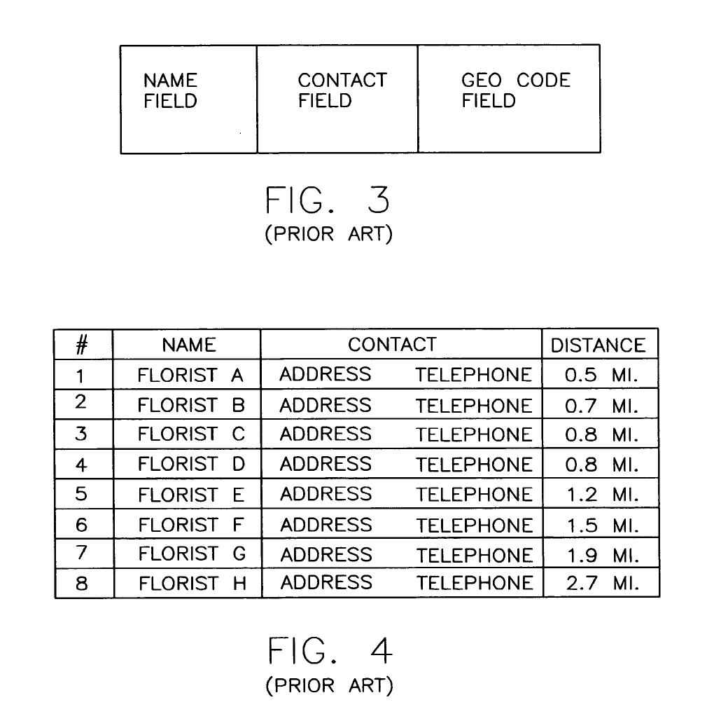

Having described the salient components of system 10, further discussion now turns to the listings stored in listing database 40. In the prior art, as shown in FIG. 3, a prior art listing typically contains a name field, a contact field and a geo-code field. The name field identifies the listing, the contact field includes the corresponding contact information and the geo-code field has the information on the location of the geographic location of the listing, such as latitude and longitudinal information.

Thus, as shown in prior art FIG. 4, a search result according to the prior art with a caller requesting a category such as “florist” in a given geographic search area/starting location such as “Bethlehem, Pa.” would provide all the results that match in an order based on distance from a point within the geographic area. Alternatively, the listings may simply be listed in an alphabetical order.

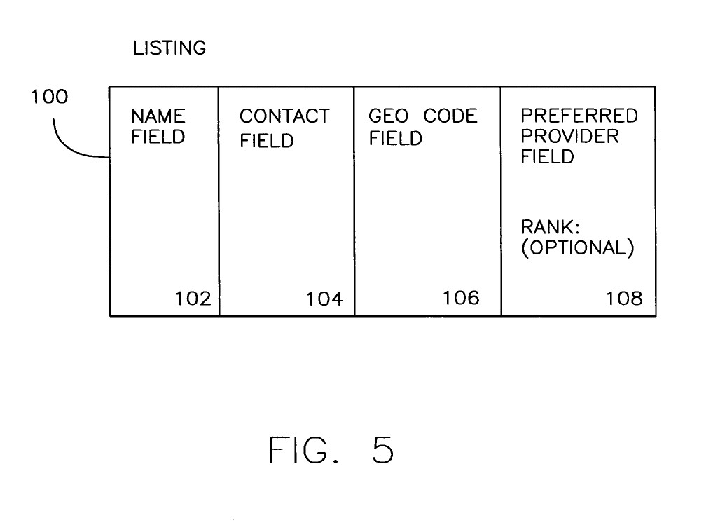

Turning now to the present invention, FIG. 5 shows a typical listing 100 stored in listing database 40 of the present invention. Listing 100 maintains a name field 102, a contact field 104, a geo-code field 106 and a preferred provider field 108. Fields 102-106 are similar to those described above, maintaining the name, contact information and geographic location of the listing.

Preferred provider field 108 maintains a notification to system 10 that the listing is a preferred provider. A preferred provider refers to any listing which has a preferred status with respect to the other listings stored in listing database 40. Preferred listings are given enhanced prominence in response to an inquiry from requester 20 such that they are more easily recognized by a customer service representative at operator terminal 36 or by requester 20 on their device in the case of an electronic search.

A typical example of a listing 100 in listing database 40 that is flagged in preferred provider field 108 is for a paid advertiser. For example, in the case of florists in a particular geographic location, one florist may pay for preferred provider status. In such a case, the associated listing for that florist will contain an indicator in the preferred provider field 108 of listing 100.

Another example for giving a preferred provider status is to provide such a status in relation to service provider associations. For example, a service provider (connectivity element 22 from FIG. 1) such as Verizon™ wireless may request that advertisers with their own directories (e.g. Yellow Pages) also be given preferred provider status with system 10. In such an instance, for example a florist who pays for an advertisement in a yellow pages directory for Verizon, will automatically get a preferred provider status listing 100 in system 10, as a result of that service provider's relationship with system 10. Such a configuration allows for additional revenue generating opportunities for both service providers and system 10 allowing the two to cross-sell advertising space to retailers.

In yet another example, system 10 may arbitrarily assign preferred provider status to a listing 100 simply for promotional reasons. It is understood that preferred provider status can be given to a listing for any number of reasons all of which are in the contemplation of the present invention.

Referring further to preferred provider status as identified in preferred provider field 108, in a first exemplary configuration, field 108 is simply marked or tagged when a listing 100 is to be considered a preferred provider listing. In such an instance, a listing 100 is either a preferred provider or it is not. Alternatively, as shown in FIG. 5, a weighting system may be employed such that scale indication is included in preferred provider field 108. For example, a ranking system of 1-5 may be employed where different values may be attached to a listing 100 that confer better preferred provider abilities as described in more detail below. For example, the scale may be related to how the preferred provider attribute was added, by pay, by association with a service provider or as a promotion. Furthermore, additional money may be used to purchase a higher preferred provider rating. The advantages of a positive marking in preferred provider field 108 are discussed in more detail below, regarding the operation of DA platform 30 when retrieving listings 100 from listing database 40 in response to query from requester 20.

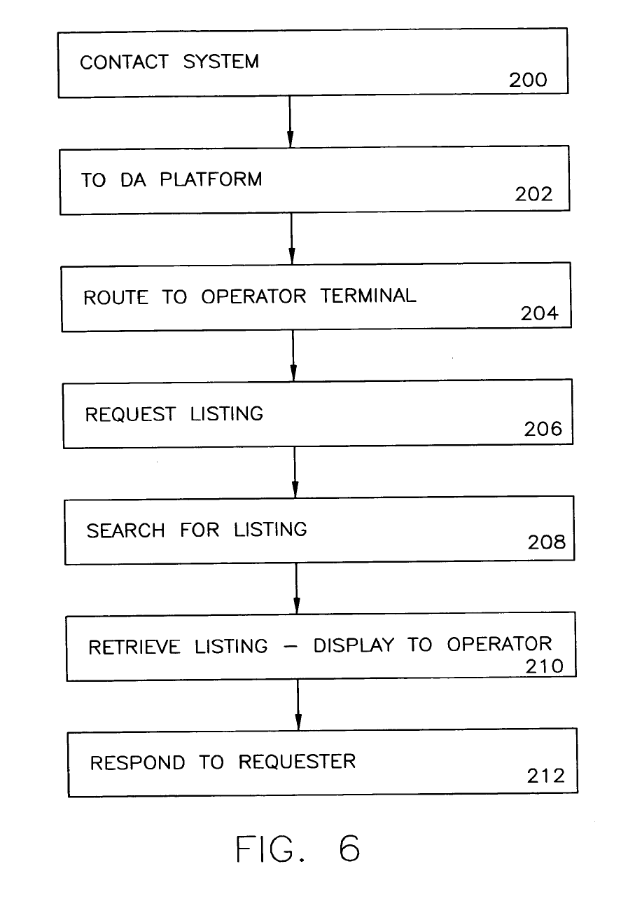

Having discussed the structure of system 10 and the listings 100 contained therein, the following outlines the operation of a typical call to system 10. In one embodiment of the present invention, as illustrated in FIG. 6, a flow diagram is given for a prototypical call to system 10 from requester 20. In a first step 200, requester 20 contacts system 10 via, connectivity element 22. For the purposes of illustration, requester 20 will be a cellular telephone caller seeking a florist in the area of Bethlehem, Pa. nearest to zip code 18017. This is understood to be for exemplary purposes and is in no way intended to limit the scope for the present invention.

In a next step 202, the call is sent into DA platform 30 for handling. Once received, at step 204, communication request handling equipment 32 routes the call to ACD 34 which in turn distributes the call to an operator terminal 36 for handling by a customer service representative. For exemplary purposes the process will be described in terms of a call from requester 20 be handled by a live operator, however this is in no way intended to limit the scope of the present invention

At step 206, requester 20 requests the desired listing in a specific selected category from the customer service representative. As noted above, in the present example it is for a florist in the area of Bethlehem Pa. 18107.

Next, at step 208 the customer service representative performs a search through listings 100 stored in listing database 40 in order to retrieve desired listings 100 having the specified category. This search may be conducted according to any standard methods of database searching including the use of categories, keywords, physical location. At step 210, DA platform 30 retrieves a series of listings 100 and displays them to the customer service representative.

Upon display, at step 212, the customer service responds to requester 20 with a listing (or listings) that meets the requirements of requester 20. As discussed above, the selected listing may be communicated verbally to requester 20 or it may alternatively be SMS's, e-mailed or otherwise electronically communicated. Furthermore, if preferred provider field 108 contains additional promotion information it can also be forwarded either verbally or electronically in either the same message or separately.

It is during steps 208-212 that the provisions of the present invention regarding the preferred provider field 108 is more clearly defined.

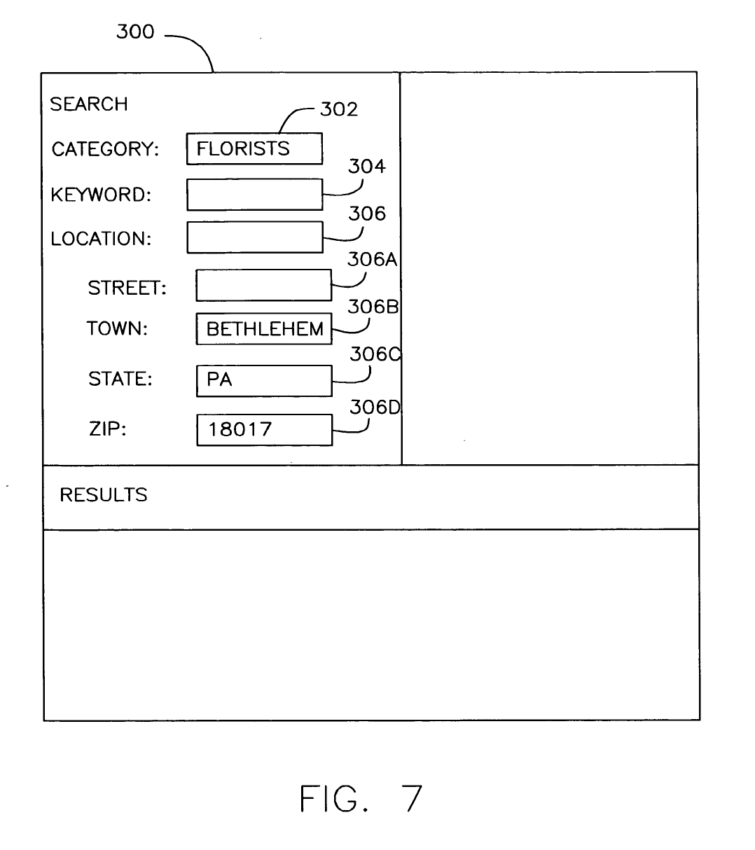

In one embodiment of the present invention, FIG. 7 is a sample search screen shot 300 used from step 208. Screen shot 300 shows a category search box 302, a keyword search box 304 and a location search box 306. Location search box 306 may have sub components street address box 306a, town box 306b, state box 306c, and zip code box 306d as well as any other criteria that may be used for conducting such location searches.

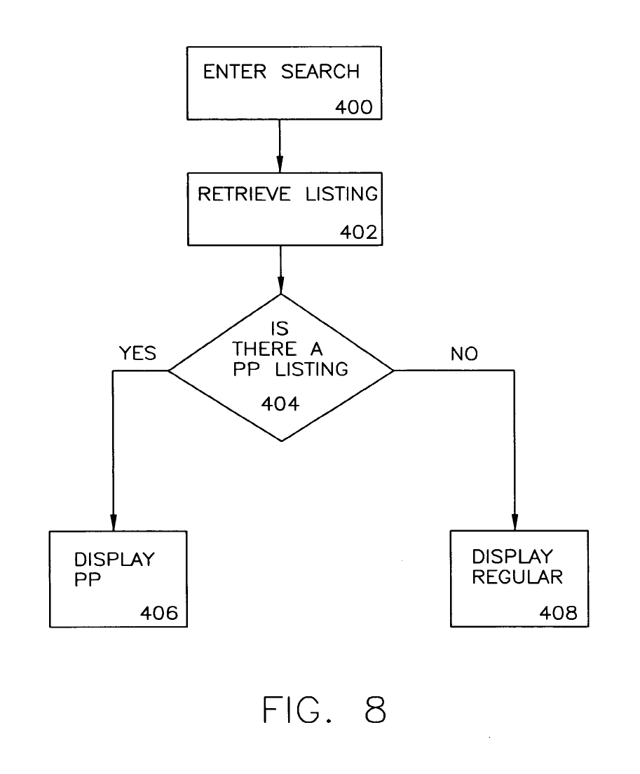

In a more detailed description of the present invention, FIG. 8 represents a flow chart for a more detailed step by step process operation of steps 208 and 210 above, where DA platform 30 performs a listing search in listing database 40.

At a first step 400, the customer service representative enters the appropriate information on the search screen as shown in search screen shot 300 in FIG. 7. At step 402, the DA platform searches listing database 40 to retrieve listings that meet the search requirements set by requester 20.

For example, in the presently used example, DA platform will search for all “florists” in “Bethlehem, Pa.”. Furthermore, these listings will be set to a particular order based on their proximity to zip code 18017. System 10 may employ any sort of standard limits such a total listing cap, such as closest 10 listings or a distance cap, such as within 5 miles, in order to reasonably limit the responses.

Next, at step 404, after retrieving the listings that meet the search requirement, DA platform 30 searches each of the retrieved listings 100 for a marker within preferred provider field 108 in order to determine if any of the listings are of a preferred status. If so, at step 406 these preferred listings 100 are given additional prominence when displayed to the customer service representative or to the requester 20 as discussed in more detail below. If not, at step 408, the listings retrieved are simply shown in normal fashion to the customer service representative.

In an alternative arrangement, it is noted that certain preferred provider features contained in preferred provider field 108 may actually allow a listing 100 that does not meet the search criteria to be retrieved anyway as a result of the preferred provider status. For example, using the above search, assume the search radius for a florist was 5 mi from zip code 18017. In the instance that listing database included a listing 100 for a florist having an active preferred provider status, but was located six miles from zip code 18017 it is possible that DA platform 30 may retrieve all of the results within five miles as well as any preferred listings within 10 miles. As such, the listing 100 for the florist six miles from zip code 18017 would also be retrieved in response to the request.

The following are possible variations and system requirements that may apply to the search and display of preferred provider listings 100.

In a first embodiment, each retrieval of listings retrieves preferably at least three listings 100 with an active preferred provider field 108. If additional preferred providers meet the search request criteria they may be dropped or rotated for later searches as discussed below. For example, over the course of a predefined number of calls system 10, preferred provider listings 100 are displayed prominently to customer service representatives at DA platform 30 a substantially equal number of times with regard to one another.

If less than three are available, system 10 may work outside the original limitations (range limitations for example) to find listings that fit the search criteria and are preferred providers. For example, if there are only two preferred provider listings 100 for florists within ten miles of zip code 18017 then DA platform 30 may expand to fifteen miles to look for an additional third preferred provider.

The selected preferred providers for prominent display to the customer service representative may be rotated on per search basis to ensure equal display. As noted above, in the case of weighted preferred provider listings, addition prominent displays for listings 100 may be provided if the owner of such a listing is paying (high paying) advertiser with system 10. System 10 may employ a pricing tool to the owners of listings 100 or to the service providers based on how often they would like their listing 100 displayed as a preferred provider listing. Here for example, listings 100 having a preferred status and a higher ranking are displayed prominently to the customer service representatives a substantially greater number of times with regard to listings 100 having a lower ranking.

In one embodiment of the present invention system 10 maintains the ability to store additional information for preferred providers. For example, if a florist is listed as a preferred provider they may wish to store their hours and web address within field 108 of their listing 100.

If requester 20 is satisfied with the listing in response to their query, then in step 212 outlined above, system 10 may SMS this information to requester 20 along with providing them the basic contact information such as the listing telephone number. It is noted that the additional information, apart from the actual contact information, may simply include promotional information such as sales or event information. In the case where requester 20 is not SMS capable the additional information may simply be read to requester 20 by the customer service representative or otherwise verbally communicated via an automated system.

In another embodiment of the present invention, when a preferred provider is selected in response to a search request from a requester 20, system 10 may request authorization for the preferred provider to actually contact the requester 20, possibly by telephone or e-mail. Furthermore, the present invention, regardless of this authorization, may e-mail or SMS a notification to the preferred provider that their listing was retrieved and displayed/read to a requester 20. Such a notice may include the search terms that lead to their listing 100 being retrieved to help the preferred provider better assess what potential customers are seeking.

It is noted that it is likely that many listings 100 with an active preferred provider status in field 108 will be national telephone numbers. For example 1-800-Florist™. In such instances when a user is asking for a particular location, such as Bethlehem, Pa., system 10 is able to maintain a rotation of national numbers as well with the preferred provider listings that are retrieved in response to the search.

Having discussed the structure and operation of system 10, the following describes the output of search carried out according to the above described.

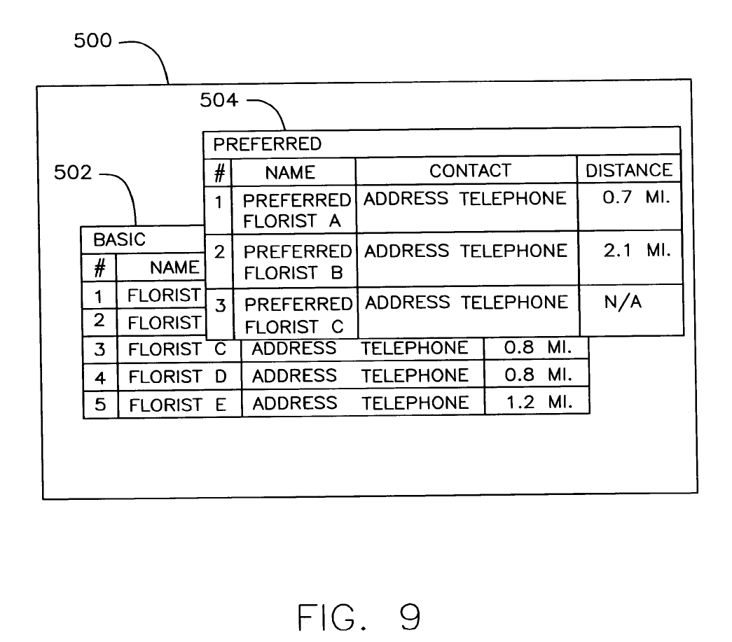

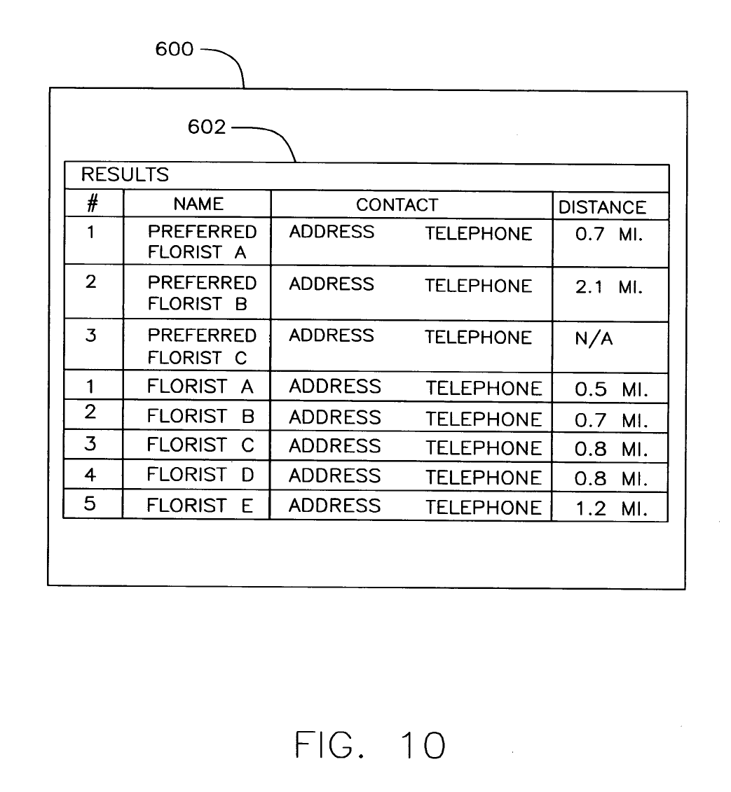

In one embodiment of the present invention as further shown in FIG. 9-11, at step 402, in addition to retrieving listings 100 with active preferred provider fields 108, system 10 also prominently displays preferred provider listings 100 to the customer service representative as discuss above.

For example, in a first option shown in FIG. 9, preferred provider screen shot 500 shows a first method for prominently displaying the preferred providers. With regard to the running example, suppose system 10 retrieved 8 florists that were within the appropriate distance from zip code 18017 in Bethlehem. Suppose further that of those listings, two were tagged as preferred providers in field 108 and third national preferred provider was also flagged. In this example, the three preferred provider listings 100 are shown in a preferred provider pop up window 502. The remaining, listings 100 are shown on the basic search results screen 504.

System 10 may preferably dim basic search results screen 504, to make sure customer service representative has no problem reading the preferred listings 100 from window 502. If a listing from preferred provider screen 502 is found acceptable to requester 20 at step 212, then the customer service representative can offer the complete contact information from contact field 104 as well as any additional information such as store hours or sale information included in preferred provider field 108. If none of the preferred provider listings 100 on preferred provider pop up window 502 are acceptable to requester 20 then the customer service representative can press “escape” or some other comparable key and continue offering the standard listings 100 from basic search screen 504.

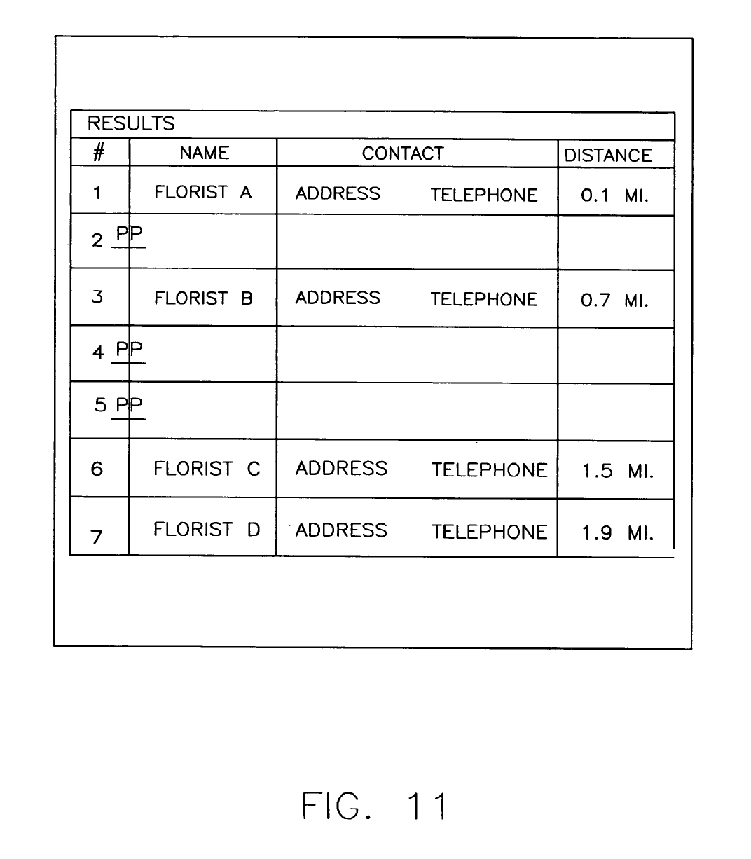

In another embodiment of the present invention as illustrated in FIG. 10, listings 100 having an active preferred provider field 108 may alternatively be displayed as shown in screen shot 600. For example, a results window 602, displays a plurality of listings 100. If any of the listings 100 have an active preferred provider field as determined in step 404 above, then those listings 100 may simply be advanced to the top results window 602.

In yet another embodiment of the present invention as illustrated in FIG. 11, listings 100 having an active preferred provider field 108 may also be displayed as shown in screen shot 700. For example, a results window 702, displays a plurality of listings 100. If any of the listings 100 have an active preferred provider field as determined in step 404 above, then those listings 100 may simply be marked with a preferred provider designation, such as “PP.” in search results window 702. Furthermore, each of the designated listings 100 may be further highlighted by changing their color, to a highlighted yellow or pink hue.

It is understood that the above examples shown in screen shots 500, 600 and 700 are intended only as examples of the prominent display of preferred provider listings. Any similar system and method that employs a prominent display of a listing having a preferred provider status is also within the contemplation of the present invention.

In one embodiment of the present invention, upon completion of a call between requester 20 and system 10, that in any way involves a listing 100 having a preferred provider status, tracking database 75 and billing database 70 monitor the activity to develop reports for both system administrators as well as the advertisers who pay for the preferred provider status for their listings.

Such stats may include but are not limited to the following categories. First, for each category such as “florists” in a given geographical region, system 10 may keep records of how many requesters 20 requested such a category and how many times a particular preferred provider listing was given (as a percentage). This can be compared against the averages for non-preferred provider listings so that paying preferred providers may see how much additional exposure they get for using the preferred provider status.

A second record that can be stored in tracking database 75 may record the number of times a preferred provider listings 100 is selected by the requester 20 when offered. This information can be compared against a second record of the number of regular non-preferred provider listings that are selected by requester 20 when a preferred provider listing 100 is given as option. Such comparison statistics would further show the effectiveness of the additional preferred provider exposure. For example, is a preferred provider listing 100 is offered twenty times to twenty different requesters 20 and it is selected by requester 20 on ten separate occasions, that will show the owner of preferred provider listing 100 that their advertising is having positive results. Additionally, showing a comparison against non-preferred listings and how often they are selected by requesters 20 versus the number of times they offered, this will further highlight the advantage of preferred provider listings 100.

Tracking database 75 may further compile stats on preferred provider listings 100, including how often they are completed verbally versus how often they are completed by electronically (by SMS for example).

In addition to such statistics beneficial for owners of preferred provider listings 100, additional statistics may be kept for the benefit of the system administrator such as the number of times a customer service representative, escapes from a preferred provider screen 502 to give a listing 100 from basic search screen 504. Also, for each preferred provider listing 100, call durations to those numbers may also be stored in tracking database. Billing database 70 is coupled to tracking database and may use any of the stored statistics in order to assist in billing of current providers and packaging offers to future advertisers who may wish to have their listing 100 given preferred provider status.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. An enhanced directory assistance system comprising:
a directory assistance platform configured to receive calls from at least one requester seeking a listing associated with a desired category of goods or services;
a listing database, coupled to said directory assistance platform configured to store a plurality of listings each having an associated category of goods or services and geographic location code, at least one listing having a preferred status,
wherein when said requester contacts said directory assistance platform seeking a listing associated with a desired category of goods or services, a customer service representative at said directory assistance platform performs a search to retrieve listings associated with said desired category that meet the requester's search requirement, and are at some standard predefined geographic distance from said location of said requester,
wherein at least one of which is a listing having a preferred status is given a more prominent display to said customer service representative than the remaining listings among said plurality of listings that do not have a preferred status, and wherein listings having a preferred status are displayed to said customer service representative within an extended predefined geographic distance from said location of said requester than the standard predefined geographic distance from said location of said requester for listings not having preferred status.
